(19) United States
(12) Patent Application Publication
(10) Pub. No.: US 2014/0006171 A1
(43) Pub. Date: Jan. 2, 2014

(54) METHOD OF OFFLINE EXPERIMENTATION ENVIRONMENT AND APPARATUS CONDUCTING THE SAME

(71) Applicants: Patrick R. Jordan, Mountain View, CA (US); Prabhakar Krishnamurthy, Pleasanton, CA (US); David Pardoe, Sunnyvale, CA (US); Chris Leggetter, Belmont, CA (US); Sergei Vassilvitskii, New York, NY (US); Chris Bartels, Sunnyvale, CA (US)

(72) Inventors: Patrick R. Jordan, Mountain View, CA (US); Prabhakar Krishnamurthy, Pleasanton, CA (US); David Pardoe, Sunnyvale, CA (US); Chris Leggetter, Belmont, CA (US); Sergei Vassilvitskii, New York, NY (US); Chris Bartels, Sunnyvale, CA (US)

(73) Assignee: Yahoo! Inc., Sunnyvale, CA (US)

(21) Appl. No.: 13/539,266

(22) Filed: Jun. 29, 2012

(51) Int. Cl. G06Q 30/02

(52) U.S. Cl. 705/14.71

(57) ABSTRACT

The present application relates to systems and computer-implemented methods for calculating a suggested market variable associated with an auction of an online advertisement realization opportunity. In some implementations, an optimization procedure may be operated, wherein the optimization procedure may comprise sending an initial market variable associated with one or more auctions to bidding agents; receiving from each of the bidding agents a response market variable associated with the initial market variable; determining according to an auction bidding rule a winning market variable from the response market variables; and substituting the initial market variable with the wining market variable. The optimization procedure may be operated repeatedly until the winning market variable stabilizes. Then the stabilized market variable may be sent to an advertiser as the suggested market variable.

### BACKGROUND

Online advertising is a form of promotion that uses the Internet and World Wide Web to deliver marketing messages to attract customers. Examples of online advertising include contextual ads on search engine results pages, banner ads, blogs, Rich Media Ads, Social network advertising, interstitial ads, online classified advertising, advertising networks, and e-mail marketing.

Ad exchanges are organization systems that associate ad buyers (e.g., advertisers and/or agents) or ad sellers (e.g., publishers) for online advertising. For example, an ad exchange may be a platform for online auctions to facilitate buying or selling of online advertisement inventory from multiple ad networks. Here “ad networks” may refer to aggregation of ad space supply from publishers, such as for provision en masse to advertisers. An example of ad exchange is Right Media Exchange (RMX) owned by Yahoo!, which is a marketplace of online advertising that enables advertisers, publishers, and ad networks to trade digital media through an application programming interface. Through a form of online auction, RMX provides publishers, i.e., media sellers, the visibility and control necessary to maximize yield while driving engagement and return on advertisement spending for media buyers. On the other hand, the expressive nature of RMX allows advertisers and/or agents to condition their bids upon various user demographic and behavioral features, and with the inclusion of real-time bidding (RTB), advertisers and/or agents may condition their bids upon information that is not available to the exchange through the use of third-party information brokers.

Thus by its nature, a modern ad exchange is a complex multi-agent system comprising multiple market participants, such as advertisers, publishers, and networks. This characteristic of modern ad exchanges provides for the ability to automate many of the strategic decisions that are made by the market participants. For example, advertising campaign optimizer agents that incorporate high-level goals elicited from advertisers may implement strategic bidding behavior on behalf of the advertisers.

Because each market participant of an ad exchange may be an independent decision maker that intelligently reacts to and/or depends from decisions from other market participants, modeling effects of algorithmic choices for an ad exchange is challenging. A common problem in optimizing ad exchanges is to understand implications of factors that are associated with mechanism choices on the marketplace. Estimating these factors requires predictions of both strategic and non-strategic market variables, respectively. For an RMX auction of an online advertisement display, a strategic market variable may include, but is not limited to, prices that each bidder (e.g., advertiser or agent attending the auction) would like to bid for the online advertisement display opportunity, and a non-strategic market variable may be, but is not limited to, when or where that online advertisement display opportunity will be realized. For example, in a bid-per-impression case, an online advertisement display opportunity is realized when an advertisement is displayed on a webpage and an impression of the advertisement is delivered, i.e., viewed, by a web user/viewer. In a bid-per-click case, the online advertisement display opportunity is realized when it is displayed on the webpage and a web user or viewer clicks it. The non-strategic market variable may also include contents of the webpage, number of users/viewers that will visit the certain page, and/or user/viewer behavior information.

Determining strategic market variables of an ad exchange may depend on not only external factors, such as non-strategic market variables, but also the mutual interaction of other participants in the ad exchange. For example, in the RMX auction of an online advertisement display stated above, an advertiser may decide his/her bidding price based on non-strategic market variables such as the number of user/viewer will visit a webpage. The price may also be affected by prior behaviors of other participants, such as how much was the winning bid in a previous auction for similar online advertisement display. If the advertiser lost the previous auction, he/she may decide to raise his/her bid in the current auction more than the previous winning bid, or if doing so costs him/her too much, he/she may decide to quit the current auction.

However, because other marketplace participants may hold a similar position as the advertiser, they too may decide to raise their bid or quit the current auction based on their judgment to the previous winning bid. Thus, the advertiser who plans to win the current auction with an optimal bid may face a dilemma that he/she may not know what he/she should bid until he/she has already made his/her bid in the first place. Since the value of strategic market variables of an ad exchange depends on intelligent interactions between participants of the ad exchange, predicting these strategic market variables remains difficult.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals may designate corresponding parts.

FIG. 1 is a schematic diagram illustrating an example embodiment of a network environment;

FIG. 2 is a schematic diagram illustrating an example embodiment of a client device;

FIG. 3 is a schematic diagram illustrating an example embodiment of a server;

FIG. 4 illustrates one procedure of an online advertisement auction; and

FIG. 5 illustrates one implementation of a method for optimizing a strategic market variable.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments and/or implementations.

Example embodiments and/or implementations of the present application relates to systems and methods of predicting strategic market variables of a marketplace environment using disparate marketplaces environments. The predictions may be used to select algorithms and parameters that optimize behaviors of the current market environment, such as behaviors of an ad exchange system. For better understanding of the present application, network environments and online advertising that example embodiments of the present application may be implemented are first introduced as follow.

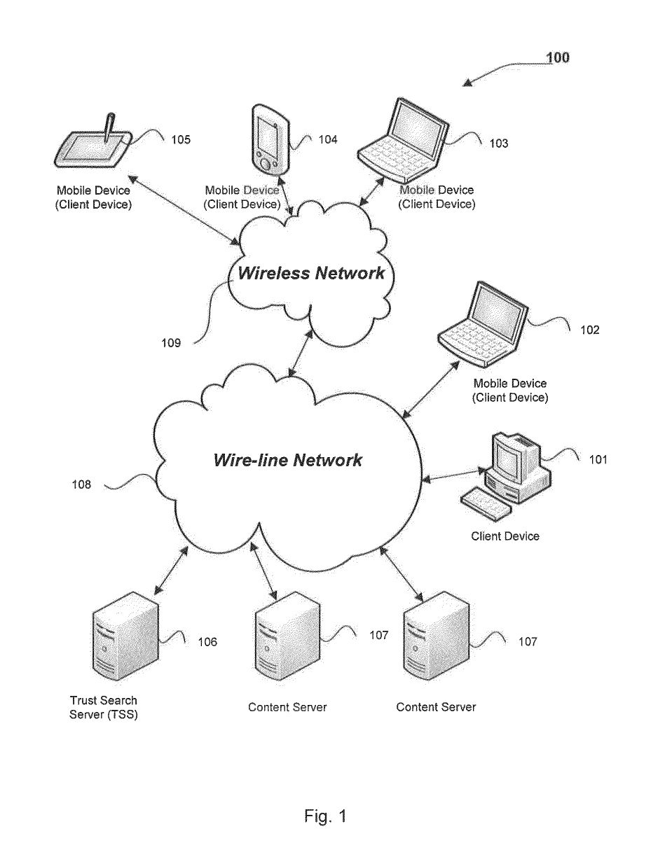

FIG. 1 is a schematic diagram of one embodiment illustrating a network environment that the methods in the present application may be implemented. Other embodiments of the network environments that may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of other implements that connect individuals via communications network or via a variety of sub-networks to transmit/share information. For example, the network may include content distribution systems, such as peer-to-peer network, or social network. A peer-to-peer network may be a network employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

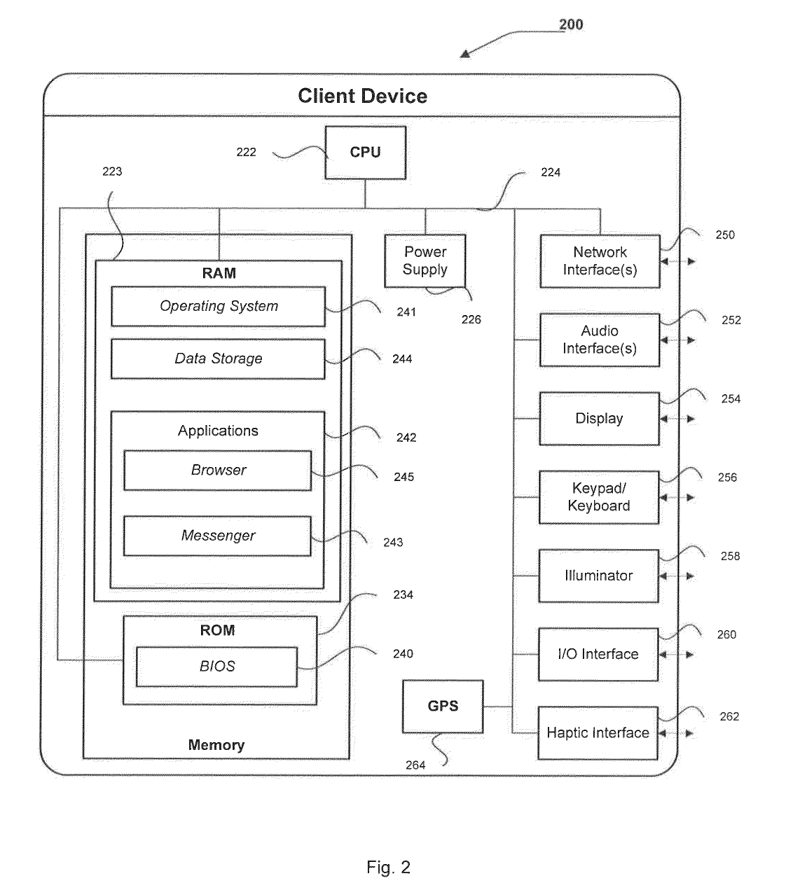

FIG. 2 is a schematic diagram illustrating an example embodiment of a client device, which may be used by an advertiser in conducting online advertising campaigns. A client device may include a computing device capable of sending or receiving signals, such as via a wired or a wireless network. A client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may vary in terms of capabilities or features. Claimed subject matter is intended to cover a wide range of potential variations. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or the like. A client device may include or may execute a variety of possible applications 242, such as a browser 245 and/or a messenger 243. A client application 242 may enable communication with other devices, such as communicating one or more messages, such as via email, short message service (SMS), or multimedia message service MMS), including via a network, such as a social network, including, for example, Facebook, LinkedIn, Twitter, Flickr, or Google, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues). The foregoing is provided to illustrate that claimed subject matter is intended to include a wide range of possible features or capabilities.

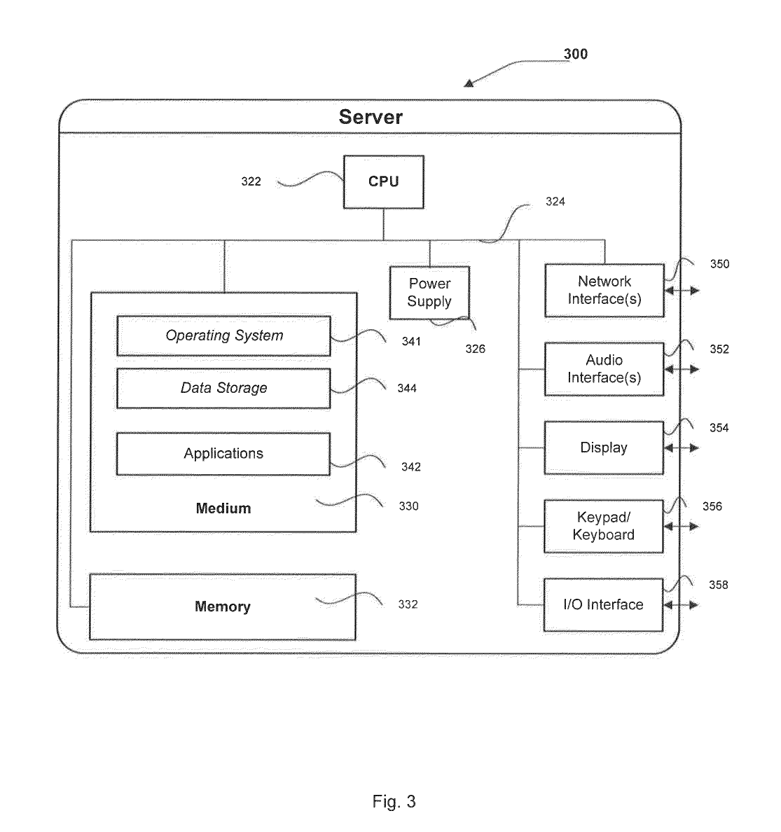

FIG. 3 is a schematic diagram illustrating an example embodiment of a server. A Server 300 may vary widely in configuration or capabilities, but it may include one or more central processing units 322 and memory 332, one or more medium 630 (such as one or more mass storage devices) storing application programs 342 or data 344, one or more power supplies 326, one or more wired or wireless network interfaces 350, one or more input/output interfaces 358, and/or one or more operating systems 341, such as Windows Server, Mac OS X, Unix, Linux, FreeBSD, or the like. Thus a server 300 may include, as examples, dedicated rack-mounted servers, desktop computers, laptop computers, set top boxes, integrated devices combining various features, such as two or more features of the foregoing devices, or the like.

The server 300 may serve as a search server 106 or a content server 107. A content server 107 may include a device that includes a configuration to provide content via a network to another device. A content server may, for example, host a site, such as a social networking site, examples of which may include, but are not limited to, Flicker, Twitter, Facebook, LinkedIn, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

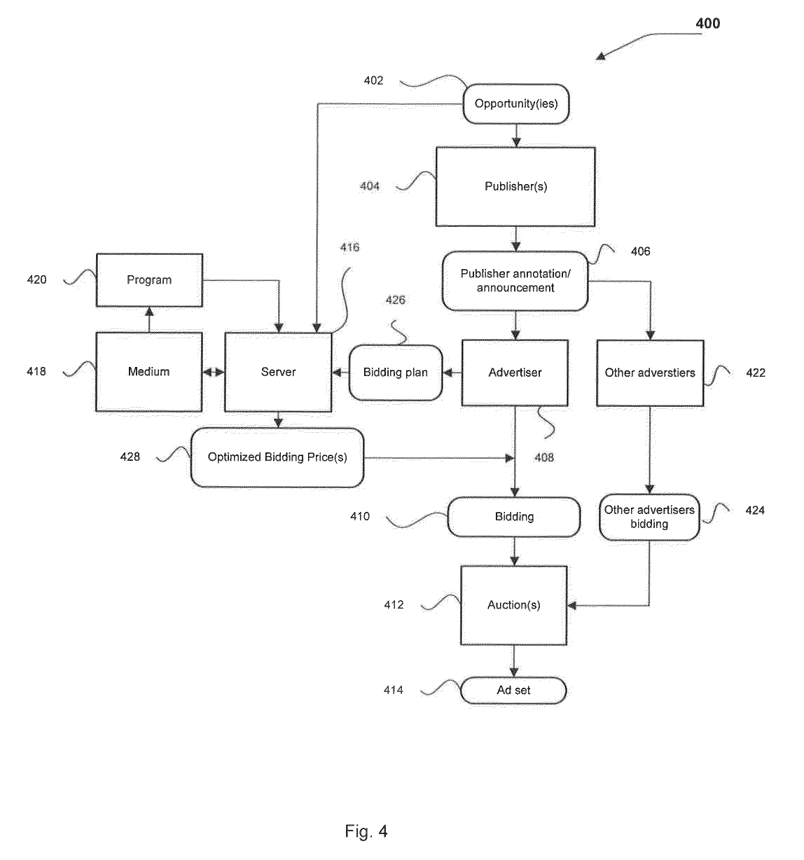

FIG. 4 is a block diagram of one example embodiment illustrating one implementation of a procedure of an online advertisement auction. However, it should be appreciated that the systems and methods described below are not limited to use with an auction for online advertisement display. In the context of ad exchange, a webpage of a publisher 404 may be viewed by various viewers and/or internet users for a number of times in a particular time period. For example, a webpage may be visited by viewers/users a million times per day. Every time when a webpage of a publisher 404 is viewed, an online advertising opportunity 402 may be created. The publisher 404 may monetize the opportunity 402 by providing the opportunity 402 to advertisers 408, 422, who are targeting their advertisements to specific users, to realize an online advertisement on that webpage through ad network/exchanges. Here, the advertiser may be any interested parties and the realization may be of any form. For convenient purposes, the present application uses display of an advertisement impression as an example of advertisement realization, but it should be noted that the description intends to include all forms of realization associated with online advertisements. For example, realization of an online advertisement may include an impression of an online advertisement, a click-through associated with an online advertisement, an action associated with an online advertisement, an acquisition associated with an online advertisement, a conversion associated with an online advertisement, or any other type of realization associated with an online advertisement that is known in the art.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements may include employing demographic characteristics (e.g., age, income, sex, occupation, etc.) for predicting user behavior, such as by group.

Advertisements may be presented to users in a targeted audience based at least in part upon predicted user behavior(s). Another approach may include profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Thus, for each online advertisement to be shown, the publisher 404 may make an annotation/announcement 406, informing advertisers 408, 422 who may be interested in the online advertisement display opportunity 402 with relevant information thereof. The relevant information may include, but may not be limited to, an advertisement key word, the website visiting information, information related to where the advertisement will be shown (such as the section of a webpage, a Uniform Resource Locater (URL) of the webpage, a location on the webpage, and/or a size of the advertisement on the webpage) and/or information about the viewers (such as their demographic information, geographic information, and/or information stored in cookies of their computer and/or internet surfing devices) of this opportunity.

Once the advertisers 408 received the annotation 406 of the online advertisement display opportunity 402 from the publisher 404, the publisher 404 may seek monetizing the online advertisement display opportunity 402 by holding an online advertisement auction 412 among the advertisers 408.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as pay-per-impression, pay-per-click, pay-per-acquisition, or any other online advertisement auction methodology known in the art. Formation of the online advertisement auction 412 may adopt a first-price rule, where the winning advertiser pays its bid, or a second-price rule, where the winning advertiser pays the minimum amount required to outbid the second-highest competitor, or any other online advertisement auction methodology known in the art. Advertiser payment for online advertising may be divided between parties including one or more publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

In the context of ad exchange, there may have multiple online advertisement display opportunities 402 occur, either from a same publisher or from different publishers, during a period of time. Each online advertisement display opportunity corresponds to an online advertisement auction 412 and in each online advertisement auction 412 there may be multiple advertisers 408, 422 participating in bidding. Each advertiser 408, 422 may independently and intelligently bid according to their knowledge of similar online advertisement auctions. Further, each advertiser 408, 422 may have his/her own plan (e.g., bidding plan) and/or budget associated with one or more strategic market variables (e.g., bidding prices) of online advertisement display. To ensure that the plan and/or budget may be successfully executed, an advertiser 408 may send the information of the opportunity 402 and his/her plan and/or budget 426 of online advertisement display to a server 416. The server 416 may access a computer-readable storage medium 418 and execute a set of instructions/programs 420 stored therein for optimizing a strategic market variable and return to the advertiser 408 the optimized strategic market variable as a suggested strategic market variable. The advertiser 408 may then use the optimized strategic market variable as reference and conduct bidding 410 in the online advertisement auction 412.

For example, in an ad exchange that constitutes two million online advertisement auctions 412, an advertiser 408 may have a plan to buy two thousand online advertisement display opportunities 402 (e.g., advertisement impressions or clicks) on slots of webpages. To this end, the advertiser 408 may participate in one million online advertisement auctions out of the two million online advertisement auctions 412 and plan to win two thousand or nearly two thousand of the online advertisement auctions with a minimum and/or desired and/or optimized budget. To ensure that the advertiser will successfully execute his/her bidding plan 426, i.e., wining two thousand or nearly two thousand online advertisement auctions over a million online advertisement auctions without spending more than he/she wishes, the advertiser 408 may send to the server 416 the plan 426 and information of one million online advertisement display opportunities 402 that are associated with the one million online advertisement auctions 412 that the advertiser 408 wishes to participate in. The server 416 may then return to the advertiser 408a suggested and/or optimized bidding plan 428, such as a prediction of bidding prices distribution of the one million online advertisement auctions. The advertiser may use the suggested and/or optimized bidding plan 428 as reference in conducting his/her bidding 410, so that he/she may win approximately two thousand real online advertisement auctions with minimum and/or desired and/or optimized expense.

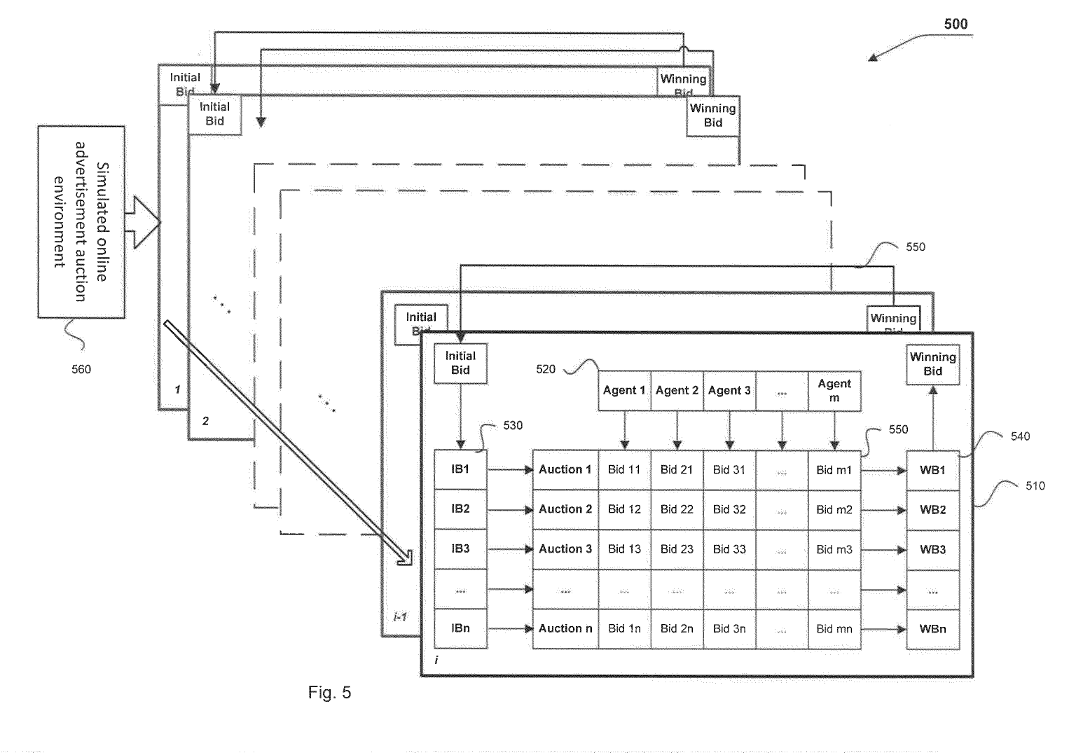

FIG. 5 illustrates one implementation of a method for optimizing a strategic market variable that may be operated by the server 416. First, the method may include constructing a simulated online advertisement auction environment 510. This may include constructing a simulation system for ad exchange. For example, the system may be a computer-implemented model that includes, but is not limited to, mechanisms, algorithms, and parameters to simulate online advertisement auctions 550, wherein the parameters of the simulated online advertisement auctions 550 may include, but are not limited to, rules of the online advertisement auctions and information of online advertisement display opportunities that are corresponds to each of the simulated online advertisement auctions. The system may also include a number of bidding agents 520, wherein each bidding agent may be a machine learning algorithm with pre-set bidding strategy simulating an actual advertiser/agent bidding in an online advertisement auction environment. The machine learning algorithms and bidding strategies of the bidding agents 520 may or may not be the same with respect to each other.

After the simulated online advertisement auction environment 560 is constructed, the method may include inputting a set of initial strategic market variables 530 to the simulated online advertisement auction environment 510. For example, the set of initial strategic market variables may be bidding prices taken from real historical online advertisement auctions, wherein the real historical online advertisement auctions may be similar to or may be different from the simulated online advertisement auctions 550, and wherein the number of historical online advertisement auctions may or may not equal to the number of simulated online advertisement auctions 550 in order to construct the set of initial strategic market variables. The set of initial strategic market variables may also be bidding prices taken from simulation results using other prediction methods, algorithms, and/or models for online advertisement auctions, wherein the number of simulation results may or may not equal to the number of simulated online advertisement auctions 550 in order to construct the set of initial strategic market variables. Each of the set of initial strategic market variables 530 may represent a historical winning strategic market in a corresponding simulated online advertisement auction 550, serving as a reference to every agents 520 in deciding their respective response in the current simulated online advertisement auction 550. For example, if the set of initial strategic market variables 530 is a set of n initial bidding prices, as shown in FIG. 5, IBₙ represents a historical winning bidding price to the n^{th} simulated online advertisement auctions Auctionₙ. The value of IBₙ is available to every agent 520 so that each agent 520 may use it as a reference in deciding its bidding price for the current simulated online advertisement auction Auctionₙ.

Next, the server 416 may carry on an optimization procedure to produce the suggested and/or optimized bidding plan 428. To this end, the server 416 may operate the simulated online advertisement auction environment 510 and receive from each agent 520 (e.g., Agentₗ˜Agentₘ as shown in FIG. 5) therein a response market variables Bidₗₗ˜Bidₘₙ according to the initial strategic market variables 530. For example, as shown in FIG. 5, Agentₘ responds to the initial bid price IBₙ for Auctionₙ with its response market variable Bidₘₙ.

The server 416 may then produce a set of winning strategic market variables 540 (e.g., WBₗ˜WBₙ as shown in FIG. 5) for the simulated online advertisement auctions 550 from the response market variables of the agents 520, pursuant to the bidding rule of the simulated online advertisement auctions 550. For example, if Auctionₙ adopts first-price rule and the strategic market variable is bidding price, the corresponding winning strategic market variable WBₙ for Auctionₙ may be the highest bidding prices among Bidₗₙ˜Bidₘₙ.

If values of the set of winning strategic market variables 540 (e.g., the winning bid values of Auctionₗ˜Auctionₙ) are the same or substantially the same as values of the set of initial strategic market variables (e.g., bidding prices of real historical online advertisement auctions), the server 416 may return the set of winning strategic market variables to the advertiser 408 as the optimized bidding plan 428.

However, if the values of the set of winning strategic market variables 540 are not substantially the same as the values of the set of initial strategic market variables 530, the server 416 may further iterate the simulated online advertisement auction environment 510 to optimize the values of the winning strategic market variables 540. To this end, the server 416 may discard the values of the set of initial strategic market variables 530 and assign the initial strategic market variables 530 with the values of the set of winning strategic market variables 540, and operate the simulated online advertisement auction environment 510 again to obtain a new set of winning strategic market variables 540.

The server 416 may keep iterating the simulated online advertisement auction environment 510 by updating the set of initial strategic market variables 530 with the set of winning strategic market variables 540 from the previous iteration until the result of the set of winning strategic market variables 540 stabilizes, i.e., the set of winning strategic market variables 540 from the current iteration is the same or substantially the same as the set of winning strategic market variables 540 from the previous iteration. The stabilized strategic market variables, i.e., the current winning strategic market variables 540, may represent a stable point of the optimization procedure where each agent 540 stops increase or decrease their bid with respect to the strategic market variables (e.g., bidding prices). That being said, using the stabilized market variables 540 as reference to his/her bid in real online advertisement auctions, the advertiser 408 may anticipate a substantially the same response from the online advertisement auctions he/she participates in.

At this point, the server 416 may stop the optimization procedure and return the stabilized strategic market variables 540 to the advertiser 408 as the suggested and/or optimized bidding plan 428 (i.e., suggested strategic market variables). By receiving the strategic market variables 428, the advertiser 408 may use it as a reference for his/her bidding in real online advertisement auctions. For example, if the suggested strategic variables are predictions for the winning prices of the one million online advertisement auctions mentioned previously (i.e., n=10,000), the advertiser 408 may select two thousand winning prices therefrom as his/her bidding prices when he/she participates in the one million online advertisement auctions. By doing so, the advertiser 408 may win approximately two thousand online advertisement display opportunities as he/she wishes.

As described above, systems and computer-implemented methods may provide for modeling evolution of a marketplace over time. The systems and methods may incorporate predictions from disparate marketplaces environments, as well as strategic predictions of the current market place environment derived from iterative methods. The systems and methods may provide suggested strategic market variables (such as bidding prices) that advertisers may use as references for participating auctions of online advertisement display opportunities. In some implementations, the described systems and methods may provide the suggested strategic market variables by taking a set of initial values of the strategic market variables from a disparate system and optimize the strategic market variables through iteration until the strategic market variables stabilize. In addition, the present application also provides programs adopting that described methods, where the programs comprise instructions stored on a computer-readable storage medium that may be executed by a processor of a device such as servers.

However, it is intended that the foregoing detailed description be regarded as illustrative rather than limiting, and that it be understood that it is the following claims, including all equivalents, that are intended to define the spirit and scope of this invention.

For example, while the above-described systems and methods have been described with respect to optimizing strategic market variables (such as bidding prices) of advertisement display auctions, it will be appreciated that the same systems and methods may be implemented to optimize the other market variables of auctions, and the auctions may or may not be related to advertisement display.

Further, while the above-described systems and methods have been described with respect to optimizing the market variables of online auctions, it will be appreciated that the same systems and methods may be implemented to optimize the market variables of auctions that are not held online and/or not related to online activities.

Also, while the above-described systems and methods have been described with respect to optimizing the market variables of auctions held by publishers and bided by advertisers, it will be appreciated that the same systems and methods may be implemented to optimize the strategic market variables of auctions held by any auction holder and bided by any auction attendances.

In addition, while example embodiments have been particularly shown and described with reference to FIGS. 1-5, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A computer-implemented method for calculating a suggested market variable associated with an auction for an online advertisement realization opportunity, the method comprising:
repeating an optimization procedure until a winning market variable stabilizes; and
returning the stabilized market variable as the suggested market variable;
wherein the optimization procedure comprises:
sending an initial market variable associated with one or more auctions for an online advertisement realization opportunity to bidding agents;
receiving from each of the bidding agents a response market variable associated with the initial market variable;
determining according to an auction bidding rule a winning market variable from the response market variables; and
substituting the initial market variable with the wining market variable.

2. The computer-implemented method according to claim 1, further comprising:
constructing a simulation system associated with an online advertisement auction environment;
wherein the simulation system comprises a computer-implemented model comprising the bidding agents, mechanisms, algorithms, and parameters to simulate the auction; and
wherein each bidding agents comprises a machine learning algorithm that simulates an actual bidder in the auction for the online advertisement display opportunity.

3. The computer-implemented method according to claim 1, wherein the initial market variable comprises at least one bidding price value, each bidding price value being a bidding price of the one or more auctions; and
wherein the response market variable from a bidding agent comprises at least one response bidding price value, each response bidding price value being a response bidding price of the agent in response to a bidding price value of the initial market value.

4. The computer-implemented method according to claim 1, wherein the initial market variable comprises a bidding price value associated with an actual historical auction of online advertisement realization; and
the suggested market variable comprises a bidding price value associated with the auction for the online advertisement realization opportunity.

5. The computer-implemented method according to claim 1, wherein the realization of an online advertisement comprises at least one of an impression of an online advertisement, a click-through associated with an online advertisement, an action associated with an online advertisement, an acquisition associated with an online advertisement, and a conversion associated with an online advertisement.

6. The computer-implemented method according to claim 1, wherein the winning strategic market variable stabilizes when the winning market variables from an earlier iteration of the optimization procedure are substantially the same as the winning market variables from a later iteration of the optimization procedure.

7. The computer-implemented method according to claim 1, further comprising:
sending a non-strategic market variable of the auction to bidding agent, wherein the non-strategic market variable comprises information relating to a number of viewers that visit a webpage associated with the online advertisement realization opportunity.

8. A computer-readable storage medium comprising a set of instructions for calculating a desired market variable associated with an auction of an online advertisement realization opportunity, the set of instructions to direct a processor to perform acts of:
repeating an optimization procedure associated with a winning market variable until the winning market variable stabilizes; and
returning the stabilized market variable as the desired market variable;
wherein the optimization procedure comprising:
sending an initial market variable associated with one or more auctions to bidding agents;
receiving from each of the bidding agents a response market variable associated with the initial market variable;
determining according to an auction bidding rule a winning market variable from the response market variables; and
substituting the initial market variable with the wining market variable.

9. The computer-readable storage medium according to claim 8, wherein the performing the acts further comprises constructing a simulation system associated with an online advertisement auction environment, wherein
the simulation system comprises a computer-implemented model comprising the bidding agents, mechanisms, algorithms, and parameters to simulate the auction; and
each bidding agents comprises a machine learning algorithm that simulates an actual bidder in the auction for the online advertisement realization opportunity.

10. The computer-readable storage medium according to claim 8, wherein the initial market variable comprises at least one bidding price value, each bidding price value being a bidding price of the one or more auctions; and
wherein the response market variable from a bidding agent comprises at least one response bidding price value, each response bidding price value being a response bidding price of the agent in response to a bidding price value of the initial market value.

11. The computer-readable storage medium according to claim 8, wherein the initial market variable comprises a bidding price value associated with an actual historical auctions of online advertisement realization; and
the suggested market variable comprises a bidding price value associated with the auction for the online advertisement realization opportunity; and
the realization of an online advertisement comprises at least one of an impression of an online advertisement, a click-through associated with an online advertisement, an action associated with an online advertisement, an acquisition associated with an online advertisement, and a conversion associated with an online advertisement.

12. The computer-readable storage medium according to claim 8, wherein the winning strategic market variable stabilizes when the winning market variables from an earlier iteration of the optimization procedure are substantially the same as the winning market variables from a later iteration of the optimization procedure.

13. The computer-readable storage medium according to claim 8, wherein performing the acts further comprising:
sending a non-strategic market variable of the auction to bidding agent, wherein the non-strategic market variable comprises information relating to a number of viewers that visit a webpage associated with the online advertisement realization opportunity.

14. A server comprising:
a computer-readable storage medium comprising a set of instructions for calculating a strategic market variable associated with an auction of online advertisement realization opportunity;
a processor in communication with the computer-readable storage medium that is configured to execute the set of instructions stored in the computer-readable storage medium and is configured to:
repeat an optimization procedure associated with a winning market variable until the winning market variable stabilizes; and
return the stabilized market variable as the desired market variable;
wherein to perform the optimization procedure, the processor is configured to:
send an initial market variable associated with one or more auctions to bidding agents;
receive from each of the bidding agents a response market variable associated with the initial market variable;
determine according to an auction bidding rule the winning market variable from the response market variables; and
substitute the initial market variable with the wining market variable.

15. The server according to claim 14, wherein the processor is further configured to construct a simulation system associated with an online advertisement auction environment;
wherein the simulation system comprises a computer-implemented model comprising the bidding agents, mechanisms, algorithms, and parameters to simulate the auction; and
wherein each bidding agents is a machine learning algorithm that simulates an actual bidder in the auction for the online advertisement realization opportunity.

16. The server according to claim 14, wherein the initial market variable comprises at least one bidding price value, each bidding price value being a bidding price of the one or more auctions; and
wherein the response market variable from a bidding agent comprises at least one response bidding price value, each response bidding price value being a response bidding price of the agent in response to a bidding price value of the initial market value.

17. The server according to claim 14, wherein the initial market variable comprises a bidding price associated with an actual historical auction of online advertisement realization; and the suggested market variable comprises a bidding price value associated with the auction for the online advertisement realization opportunity; and
the realization of an online advertisement comprises at least one of an impression of an online advertisement, a click-through associated with an online advertisement, an action associated with an online advertisement, an acquisition associated with an online advertisement, and a conversion associated with an online advertisement.

18. The server according to claim 14, wherein the bidding rule is one of a second-price bidding rule and a first-price bidding rule.

19. The server according to claim 14, wherein the winning strategic market variable stabilizes when the winning market variables from an earlier iteration of the optimization procedure are substantially the same as the winning market variables from a later iteration of the optimization procedure.

20. The server according to claim 14, wherein the processor is further configured to send a non-strategic market variable of the auction to bidding agent, wherein the non-strategic market variable comprises information relating to a number of viewers that visit a webpage associated with the online advertisement realization opportunity.
